(19) United States
(12) Patent Application Publication
(10) Pub. No.: US 2016/0373441 A1
(43) Pub. Date: Dec. 22, 2016

(54) PROVIDING SECURE NETWORKS

(71) Applicant: Avaya Inc., Santa Clara, CA (US)

(72) Inventor: Seema SIRIVARA, Bangalore (IN)

(73) Assignee: AVAYA INC., Santa Clara, CA (US)

(21) Appl. No.: 14/740,454

(22) Filed: Jun. 16, 2015

(51) Int. Cl. H04L 29/06; H04L 9/08

(52) U.S. Cl. CPC H04L 63/0869; H04L 9/0861

(57) ABSTRACT

Implementations generally relate to providing secure networks. In some implementations, a method includes determining one or more nodes in a network system with at least one port that is enabled for security enabled services. The method also includes provisioning a connectivity association for each node, wherein each connectivity association is provisioned with a connectivity association key. The method also includes associating each connectivity association with a virtual service network (VSN). The method also includes mutually authenticating nodes on each VSN based on each respective connectivity association key.

### BACKGROUND

Communication networks are widely used to provide communication between different computer systems and other electronic devices. Communication networks offer increased convenient access to client devices, such as computers, phones, and other devices, by allowing network communications between these devices without the need for wired connections. Various methods are available that provide increased security in networks such as in a virtual local area networks (VLANs). For example, encryption keys may be exchanged to increase security in a network system.

### BRIEF DESCRIPTION OF THE DRAWINGS

FIG. 1 illustrates a block diagram depicting an example network environment, according to some implementations.

FIG. 2 illustrates an example flow diagram for providing secure networks, according to some implementations.

FIG. 3 illustrates a block diagram of an example computing device, according to some implementations.

### DETAILED DESCRIPTION

Implementations described herein provide secure networks, including data encryption, data integrity checks, and origin authentication on a per virtual services network (VSN) basis. As described in more detail below, implementations combine network virtualization technology enabled by shortest path bridging (SPB) with security technology enabled by media access control security (MACsec).

In some implementations, a system determines one or more nodes in a network system with at least one port that is enabled for security enabled services such as MACsec. The system also provisions a connectivity association for each node, wherein each connectivity association is provisioned with a secret key referred to as a connectivity association key (CAK). Encryption keys referred to as secure association keys (SAK) may be derived from the CAK. As described in more detail below, implementations provide one-touch provisioning that enables secure data. The system also associates each connectivity association with a VSN such as an SPB VSN. The system also mutually authenticates nodes on each VSN, based on each respective connectivity association key. As a result, encryption occurs at the VSN level.

Implementations may apply to any suitable network nodes such as switches and routers, which are described in more detail below. Implementations provide secure data transmission and reception on a per SPB VSN basis, where traffic on VSNs is received and transmitted in an encrypted fashion. This prevents common security threats such as vampire-tap, man-in-the-middle attacks, etc. Implementations are highly beneficial for cloud service providers who can provide differentiated services based on security requirements.

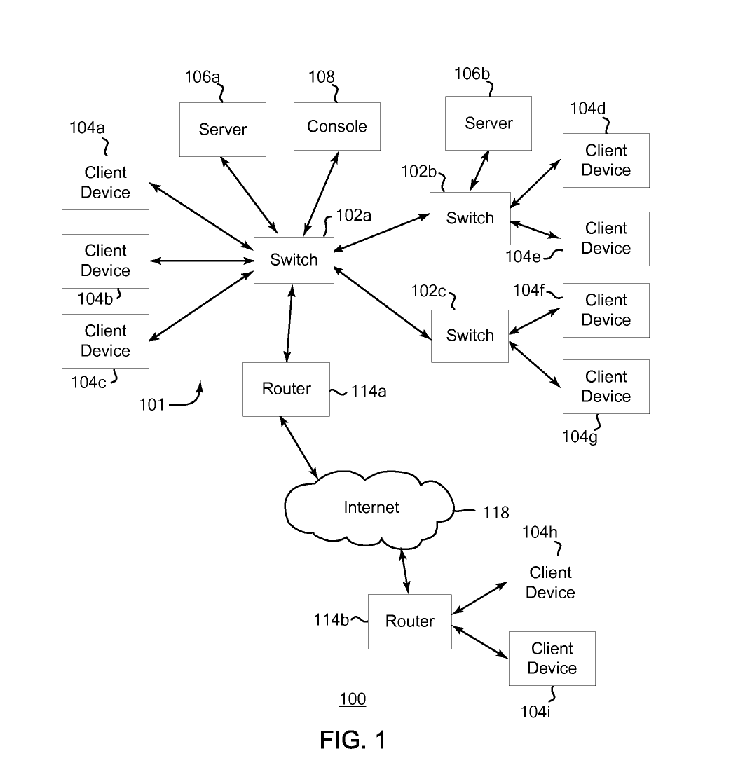

FIG. 1 is a block diagram of an example network system 100, which may be used to implement some implementations described herein. The network system 100 or “system 100” may include a network 101 providing communication links between multiple devices connected to the network. Network 101 may be any type of network that connects devices, such as a wide area network (WAN), local area network (LAN), or others types of networks. Any of various networking standards can be used for network 101, such as Ethernet.

Network system 100 may include peer nodes such as switches 102 to connect various other devices to each other and to allow them to communicate via the network communication links. Switches 102 may also be referred to as switches 102a, 102b, and 102c. In various implementations, switches 102a, 102b, and 102c function as the peer nodes of the multi-chassis cluster denoted by 102. Also, the terms peer nodes and switches 102 may be used interchangeably.

In the example of FIG. 1, client devices 104a, 104b, and 104c and server 106a are connected to switch 102a. Client devices 104d and 104e and server 106b are connected to switch 102b. Client devices 104f and 104g are connected to switch 102c.

Each peer node or switch 102 is a network device, which is referred to herein as a controller for the network, and which enables devices to communicate with each other over the network. Each switch 102 may include various types of devices as a switch, router, bridge, or hub. In some implementations, switches 102 can be managed switches, allowing commands to modify the operation of the switch. Furthermore, a single switch 102 as shown in FIG. 1 can represent one or more switches, such as a switch stack. A switch 102 includes a number of connections or ports, where each communicating device on the network can be connected to a port of the switch. Some implementations of a switch 102 allow multiple network devices to be connected to a single port of a switch 102. The switch manages the data communications between each device connected to it, such as sending data from one client device to a different client device or to a server that is the intended destination of the sender. In some implementations, a switch 102 can be connected to one or more other switches 102. For example, in FIG. 1, switch 102a is connected to switch 102b and to switch 102c. Multiple switches can be connected in the network system 100 to provide additional ports, locate ports in different physical areas, provide backup functionality, aid troubleshooting and testing, and/or provide other functions.

Each client device 104 and server device 106 can be any of a variety of types of devices. For example, in some implementations, client devices 104 and/or servers 106 can be implemented as desktop computers, laptop computers, tablet computers, portable devices, cell phones, media players, entertainment devices (television, disc player, stereo), mainframe computer, peripherals (printer, scanner, sensors), or other electronic devices.

Some implementations can use one or more of the servers 106 and/or client devices 104 as a repository for data and/or logs collected by the switches 102. For example, server 106a can provide storage for data collected by switch 102a, and server 106b can provide storage for data collected by switch 102b. Some implementations can provide dedicated storage associated with each switch 102. For example, a switch 102 may include internal storage, or may be connected to dedicated storage for the switch via a separate communication interface.

In some implementations, one or more switches 102 can be connected to another type of network device such as routers 114. In some examples, router 114a can interface the network 101 with one or more other networks. For example, the router 114a can be connected to a WAN such as the Internet 118, which is in turn connected to a network 118 via a router 114b. In one example, router 114b can include a switch network device that is connected to client devices 104h and 104i. For example, router 114a can forward any data from client devices 104 or servers 106 on network 101 via the Internet 118 to router 114b and client devices 104h and/or 104i. Likewise, router 114a can receive data intended for client devices 104 or server 106 on network 101 from the Internet 118, originating from network 118 or other source. Communication links of the networks that handle greatly increased traffic between network nodes, such as between different networks, can be considered trunk lines or trunk paths.

In some implementations, one or more of the switches 102 can be connected to a console 108. Console 108 can be any electronic device, such as a device similar to a client device 104, that allows a system administrator or other user to directly connect to the switch 102 to read status and other data from the switch 102 as well as provide instructions or commands to configure and control the operation of the switch 102. In some embodiments, the console 108 is connected to the switch via a serial port, Universal Serial Bus (USB) connection, or other type of interface that is not a connection of the network 101. Some implementations allow any of the client devices 104 to act as a console and provide console functions, using the network 101 as a connection to the intended switch 102.

Network devices such as switches 102 and/or routers 114 can be provided with functionality described herein to autonomously perform network tasks, as described in greater detail below. In some implementations, multiple such network devices of the network system 100 can be provided with this functionality and used to collect data and control functions at different nodes and connections of the network. In some implementations, different network devices can be instructed to perform different types of network tasks.

According to various implementations described herein, peer nodes in the cluster autonomously perform network tasks. If any one peer node becomes inactive, other peer nodes in the cluster can take over tasks of the inactive peer node. These tasks include actions or operations of the network device that relate to activity on the network. For example, such activity can be data sent and received at the ports of the network device, and/or the states of components of the network device that are associated with occurring network activity. The activity can be responses or activity of other devices connected to the network. In some implementations, network tasks can generally be of two types: data collection and control. For either data collection or control tasks, the network device can operate as an autonomous device according to features described herein.

Data collection (or data gathering) can be used in troubleshooting, testing, and general network monitoring uses. One example of a data collection network task is to have the network device monitor data traffic on the network and collect the results of the monitoring. Received instructions can, for example, instruct the router to count packets or other data units per time unit. In some implementations, the network device can monitor data passing through the ports of the network device and collect relevant statistical data about the data traffic. This can be performed directly by the network device itself with no need to use the network connections, thus providing more reliable monitored data due to no restrictions from other data traffic, as well as freeing up bandwidth on the network for other uses. In some implementations, a network device can determine and monitor data flowing through other ports or connections of the network. For example, some types of network devices can send out test data to particular ports or connections and determine when a response is returned, thus indicating bandwidth or other characteristics of ports on other network devices. A network device can store, or can be instructed to store, collected data to one or more particular data repository storage devices, such as a client device or server over the network or storage included in or directly accessible by the network device. In some examples, if no repository is specified, then a default repository storage device can be used.

Another example of a data collection task is capturing state information from the network device. This captured data can be sent to and stored in a data repository. The state information can be related to network activity. In some examples, the current CPU utilization of the network device can be monitored by the network device itself. Similarly, the current utilization of memory on the network device can be monitored by the network device. For example, the network device can determine how much memory is free, how much memory has been allocated, the size of blocks of memory, the extent of fragmentation in memory, etc. Furthermore, the state information can include port states (e.g., enabled or disabled), and interface up/down status. State information can also include current information stored in tables of the network device, which can be examined by the network device and values captured and stored. Such tables can include routing tables (e.g., in a router) holding values indicating routes to different network destinations. MAC address tables can also be examined, which hold MAC addresses indicating which devices are active on and connected to the network, and allowing the identity of the connected devices to be determined. The MAC addresses can also indicate where in the network the particular machines are connected. An address resolution protocol (ARP) table can also be examined and its values captured, to find information linking MAC addresses to Internet protocol (IP) addresses and to determine corresponding network activity. Protocol states handled by the network device can also be monitored and collected, e.g., transaction states for such protocols as open shortest path first (OSPF), routing information protocol (RIP), virtual router redundancy protocol (VRRP), spanning tree protocols (STP), link layer discovery protocol (LLDP), link aggregation control protocol (LACP), virtual LACP (VLACP), etc. Other device states including indicator light status or other readout status of the network device can also be captured. Overall, the data collection tasks can take snapshots of network devices and network activity, including the tables described above, routing activity, port enable and data traffic statistics, and other information for historical analysis of network activity and network growth planning.

Another type of network task is a control network task. These tasks cause the network device to perform an action or utilize a function of the network device, which can be related to network activity. In some cases the controlled network device function may affect other components of the network. A control network task allows hardware control to a user without an external device or host having to send commands to the network device to perform the control functions.

One example of a control network task is enabling and disabling ports of the network device to enable or disable data communication via those ports. This can be performed for a variety of different functions and results. For example, ports can be enabled and disabled to perform testing of the network device, testing of other network devices, and/or testing of connections in the network. In one testing example, the network device can enable and disable one or more of its ports as a testing stimulus to test its own functionality and characterize its own behavior in response to the execution of network tasks.

Some implementations can use control network tasks to control connectivity of the network, such as for security purposes. For example, there may be connections into the network that have availability only during certain times. A scheduled network task can instruct one or more switches to control the access to those connections by enabling and disabling appropriate ports of the switches at appropriate times. In some implementations, a control network task can instruct one or more switches to disable particular ports while backups or other system activities are being performed on the network.

The network device can also be instructed in some implementations to enable or disable power output on its ports. For example, a network device can be instructed via control tasks to turn on or off the power provided on its ports to other specified devices connected to its ports, such as power over Ethernet (PoE) devices that receive at least a portion of their operating power over the network connections. Some implementations can also use control tasks to change the priority of ports under particular conditions, such as which ports have priority to receive power when system power goes too low.

Control tasks can also be used to turn on or off the use of particular network communication protocols by the network device, and/or toggle or change protocol states, such as transaction states. Other features of the network device can be similarly turned on or off using control network tasks.

The data derived from network tasks such as data collection tasks and/or control tasks can be stored in a repository accessible to a system administrator or other user. For example, a user need only connect and download data from the repository to display desired network data at a console or management client device. For data collection tasks, the collected data describing the monitored network activity can be sent to the repository for storage. For control tasks, data indicating one or more results of the control tasks can be stored, such as indications of success or failure and/or related data.

The network tasks of the network device can be performed according to predetermined conditions that may have been instructed by a user. For example, such conditions can include time conditions, such as times to perform tasks as listed in a schedule. Other types of conditions may also be used to trigger particular network tasks. Some examples of conditions are described in greater detail below.

A software application stored in a memory or computer-readable storage medium provides instructions that enable a processor to perform these functions and other functions described herein.

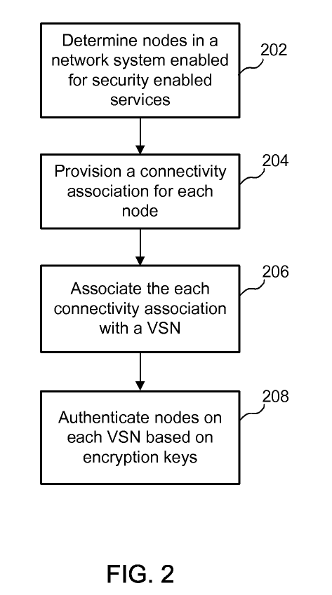

FIG. 2 illustrates an example flow diagram for providing secure networks, according to some implementations. Referring to both FIGS. 1 and 2, the method is initiated in block 202, where a node of network system 100 determines one or more nodes in a network system with at least one port that is enabled for security enabled services. The node of network system 100 may represent any switch 102 of network system 100 (e.g., switch 102a, switch 102b, 102c, etc.).

In various implementations, the one or more ports are Ethernet ports, and the node of system 100 identifies Ethernets ports that participate in media access control security (MACsec) enabled services. In various implementations, MACsec defines a construct referred to as a “connectivity association,” and the connectivity association defines a secure relation between entities participating in the MACsec service. MACsec is defined in the IEEE 802.1AE standard. While conventional MACS operates on a per Ethernet port level, implementations described herein perform encryption on a per SPB VSN basis, which is described in more detail below.

In block 204, the node of system 100 provisions a connectivity association for each node, where each connectivity association is provisioned with a secret key referred to as a connectivity association key (CAK). As indicated herein, encryption keys known as security association keys (SAKs) may be derived from a CAK. In some implementations, system 100 enables multiple encryption keys to be derived from the CAK, which in turn may be used for data encryption, data integrity checks, and origin authentication functionalities.

In block 206, the node of system 100 associates the each connectivity association with a virtual service network (VSN). In various implementations, each connectivity association is assigned an identifier (ID) for a service instance (I-SID) or secure VSN. The ID identifies that I-SID or secure VSN as a participant in that connectivity association. Such associations with secure VSNs are advantageous over conventional port-based MACsec, because associations with secure VSNs provide granularity on a per VSN basis that is not available in conventional solutions.

As such, in various implementations, each connectivity association identifies a shortest path bridging (SPB) virtual service network (VSN) to be enabled for security enabled services, where all endpoints of that VSN participate in MACsec enabled services.

In block 208, the node of system 100 mutually authenticates nodes on each VSN based on each respective connectivity association key. In some implementations, in connection with system 100 authenticating nodes on a given VSN, the node of system 100 generates an intermediate system to intermediate system (ISIS) type-length-value (TLV). In various implementations, an ISIS TLV may be used to establish adjacencies between nodes (e.g., Ethernet switches). In some implementations, the node of system 100 scrambles the CAK. The node of system 100 may scramble the CAK using any suitable scrambling technique. In various implementations, the node of system 100 includes the scrambled CAK in the TLV. The node of system 100 then MACsec enabled services capabilities for the node. In various implementations, the node of system 100 advertises MACsec capabilities for the node along with the scrambled CAK in the TLV. As a result, encryption occurs at the VSN level.

In various implementations, upon reception of the ISIS TLV, the receiving node unscrambles the CAK using any suitable technique and compares the CAK with the pre-provisioned key on that node. If they match, the sender node is authenticated and vice versa.

In some implementations, if any of the nodes participating in the secure VSN is not MACsec capable, the ISIS TLV would not be advertised and a policy may be configured to exclude that node from the secure VSN. As a result, no traffic will reach that node of the VSN.

After the secure VSN endpoints are established, the node of system 100 builds VSN trees based on the mutual authentications. In various implementations, the node of system 100 builds SPB VSN multicast and unicast trees including only those nodes that have been mutually authenticated. All data traffic on the VSN is then encrypted by looking into the I-SID ID present in an I-TAG.

Implementations described herein provide various benefits. For example, implementations enable per VSN based security services such as data encryption, data integrity checks, and origin authentication functionality. Implementations described herein are highly beneficial for cloud service providers who can provide differentiated services based on security requirements and in turn have differentiated price points for these services. Implementations described herein also avoid the need for end customers to build in application encryption capabilities, improving the time to service and market such applications. Implementations also eliminate the need for stringent hardware requirements on the server blades that run these applications with in-built encryption.

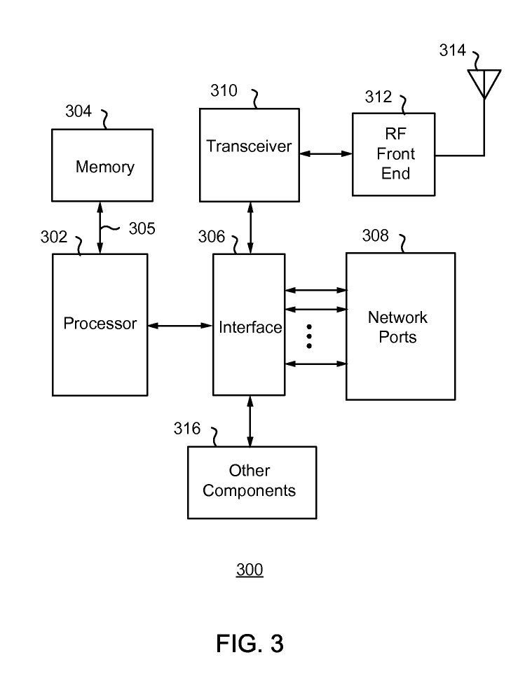

FIG. 3 illustrates a block diagram of an example computing device, according to some implementations. Device 300 can be, for example, a controller, an access point, a switch, or any device that performs switching and achieves switching redundancy, etc. In a basic configuration, device 300 typically includes one or more processors 302 and a system memory 304. A memory bus 305 can be used for communicating between processor 302 and system memory 304.

Depending on the desired configuration, processor 302 can be of any type of processing circuitry including but not limited to one or more microprocessors, microcontrollers, digital signal processors (DSPs), application specific integrated circuits (ASICs), or any combination thereof. In some examples, processor 302 can include one or more levels of caching, a processor core, and registers. An example processor core can include an arithmetic logic unit (ALU), a floating point unit (FPU), a digital signal processing core (DSP), or any combination thereof. A memory controller can also be used with processor 302, or, in some implementations, a memory controller can be an internal part of processor 302.

System memory 304 can store data used in the operation of the device 300. For example, device 300 and system memory 304 can store an operating system for the controller, one or more applications for the controller, and program data. In some implementations, the memory 304 can store software operative to perform network device functionality as well as read the instructions sent by an administrator or other user to the device and perform other functions as described above, including reading and executing commands and parameters, receiving information from associated access points, and performing blocks of methods described herein using one or more processors. For example, access point profiles providing configurations for access points, and/or software images and/or parameters for sending to be installed on access points, can be stored in memory 304. Furthermore, a signal coverage map can be stored in memory 304 representing the coverage of associated access points in the network, and/or all access points in the network. Alternatively, the software can be implemented as hardware or a combination of hardware and software. Memory 304 can be implemented as one or more of various types, volatile and/or non-volatile, including RAM, ROM, EEPROM, flash memory or other memory technology, etc.

An interface 306 can be used to interface the processor 302 with other functional components of the device 300. Such other components can include network ports 308 of the device 300 which are connected to other devices on the network to allow communication of data to and from other network devices. For example, Ethernet, Universal Serial Bus (USB), or other types of ports can allow wired network communication to the device 300. A transceiver 310 can be connected to interface 306 to allow transmission and reception of signals at the device 300. For example, an RF front end 312 and antenna 314 can allow transmission and reception of RF signals, as well as conversion between analog signals used in the communication and digital signals used by the device 300. Signals of other frequencies can be communicated in other implementations.

Additional components 316 can also be connected to interface 306. For example, storage devices can be connected to the interface 306, such as CD-ROM, DVD, or other optical storage, magnetic tape storage, magnetic disk storage or other magnetic storage devices, solid state memory storage, or any other medium which can be used to store the desired information and which can be accessed by device 300. Any such computer storage media (including memory 304) can be part of or accessible by device 300. Example computer storage media can include volatile and nonvolatile, removable and non-removable media implemented in any method or technology for storage of information, such as computer readable instructions, data structures, program modules, or other data.

Although the description has been described with respect to particular embodiments thereof, these particular embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

In general, it should be understood that the circuits described herein may be implemented in hardware using integrated circuit development technologies, or via some other methods, or the combination of hardware and software that could be ordered, parameterized, and connected in a software environment to implement different functions described herein. For example, the embodiments may be implemented using a general purpose or dedicated processor running a software application through volatile or non-volatile memory. Also, the hardware elements may communicate using electrical signals, with states of the electrical signals representing different data. It should be further understood that this and other arrangements described herein are for the purposes of example only. As such, those skilled in the art will appreciate that other arrangements and other elements (e.g., machines, interfaces, functions, orderings, and groupings of functions, etc.) may be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural terms and/or singular term herein, those having ordinary skill in the art can translate from the plural to the singular and/or from the singular to the plural as is appropriate to the context and/or application. The various singular/plural permutations may be expressly set forth herein for sake of clarity.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those of ordinary skill in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general, such a construction is intended in the sense that one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Any suitable programming language may be used to implement the routines of particular embodiments including C, C++, Java, assembly language, etc. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable non-transitory processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication, or transfer, of data may be wired, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A computer-implemented method comprising:
determining one or more nodes in a network system with at least one port that is enabled for security enabled services;
provisioning a connectivity association for each node, wherein each connectivity association is provisioned with a connectivity association key;
associating each connectivity association with a virtual service network (VSN); and
mutually authenticating nodes on each VSN based on each respective connectivity association key.

2. The method of claim 1, wherein the one or more ports are Ethernet ports.

3. The method of claim 1, further comprising enabling multiple encryption keys to be derived from the connectivity association key.

4. The method of claim 1, further comprising generating an intermediate system to intermediate system (ISIS) type-length-value (TLV).

5. The method of claim 1, further comprising scrambling the connectivity association key.

6. The method of claim 1, further comprising advertising media access control security (MACsec) capabilities for the node.

7. The method of claim 1, further comprising building VSN trees based on mutual authentication.

8. A non-transitory computer-readable storage medium carrying program instructions thereon, the instructions when executed by one or more processors cause the one or more processors to perform operations comprising:
determining one or more nodes in a network system with at least one port that is enabled for security enabled services;
provisioning a connectivity association for each node, wherein each connectivity association is provisioned with a connectivity association key;
associating each connectivity association with a virtual service network (VSN); and
mutually authenticating nodes on each VSN based on each respective connectivity association key.

9. The computer-readable storage medium of claim 8, wherein the one or more ports are Ethernet ports.

10. The computer-readable storage medium of claim 8, wherein the instructions further cause the one or more processors to perform operations comprising enabling multiple encryption keys to be derived from the connectivity association key.

11. The computer-readable storage medium of claim 8, wherein the instructions further cause the one or more processors to perform operations comprising generating an intermediate system to intermediate system (ISIS) type-length-value (TLV).

12. The computer-readable storage medium of claim 8, wherein the instructions further cause the one or more processors to perform operations comprising scrambling the connectivity association key.

13. The computer-readable storage medium of claim 8, wherein the instructions further cause the one or more processors to perform operations comprising advertising media access control security (MACsec) capabilities for the node.

14. The computer-readable storage medium of claim 8, wherein the instructions further cause the one or more processors to perform operations comprising building VSN trees based on mutual authentication.

15. A system comprising:
one or more processors; and
logic encoded in one or more tangible media for execution by the one or more processors and when executed operable to perform operations comprising:
determining one or more nodes in a network system with at least one port that is enabled for security enabled services;
provisioning a connectivity association for each node, wherein each connectivity association is provisioned with a connectivity association key;
associating each connectivity association with a virtual service network (VSN); and
mutually authenticating nodes on each VSN based on each respective connectivity association key.

16. The system of claim 15, wherein the one or more ports are Ethernet ports.

17. The system of claim 15, wherein the logic when executed is further operable to perform operations comprising enabling multiple encryption keys to be derived from the connectivity association key.

18. The system of claim 15, wherein the logic when executed is further operable to perform operations comprising generating an intermediate system to intermediate system (ISIS) type-length-value (TLV).

19. The system of claim 15, wherein the logic when executed is further operable to perform operations comprising scrambling the connectivity association key.

20. The system of claim 15, wherein the logic when executed is further operable to perform operations comprising advertising media access control security (MACsec) capabilities for the node.
